(19) United States
(12) Patent Application Publication
(10) Pub. No.: US 2018/0146502 A1
(43) Pub. Date: May 24, 2018

(54) BASE STATION APPARATUS, TERMINAL APPARATUS, AND COMMUNICATION METHOD

(71) Applicant: SHARP KABUSHIKI KAISHA, Sakai City, Osaka (JP)

(72) Inventors: HIROMICHI TOMEBA, Sakai City (JP); RYOTA YAMADA, Sakai City (JP); KATSUYA KATO, Sakai City (JP); JUNGO GOTO, Sakai City (JP); OSAMU NAKAMURA, Sakai City (JP); TOMOKI YOSHIMURA, Sakai City (JP); YASUHIRO HAMAGUCHI, Sakai City (JP)

(21) Appl. No.: 15/573,648

(22) PCT Filed: May 13, 2016
(86) PCT No.: PCT/JP2016/064222

§ 371 Date: Nov. 13, 2017

(30) Foreign Application Priority Data
May 14, 2015 (JP) 2015-098653

(51) Int. Cl. H04W 76/15; H04W 72/12; H04W 88/06

(52) U.S. Cl. CPC H04W 76/15; H04W 72/1289; H04W 74/04; H04W 72/1273; H04W 88/06; H04W 72/1215

(57) ABSTRACT

A base station apparatus, a terminal apparatus, and a communication method that make it possible to achieve reduction in delay of communication are provided. A base station apparatus of the present invention is a base station apparatus for performing communication with a terminal apparatus under a first communication scheme or a second communication scheme. The first and second communication schemes differs in allowable delay time from each other. The base station apparatus notifies the terminal apparatus of pre-scheduling information including information indicating a plurality of resource candidates that are used in the first communication scheme. The base station apparatus enters a receiving operation of the first communication scheme in a resource indicated by the plurality of resource candidates.

### TECHNICAL FIELD

The present invention relates to a base station apparatus, a terminal apparatus, and a communication method.

### BACKGROUND ART

In a communication system according to 3GPP (Third Generation Partnership Project), such as LTE (Long Term Evolution) or LTE-A (LTE-Advanced), a communication area can be enlarged by a cellular configuration including a cell arrangement of areas covered by base station apparatuses (base stations, transmitting stations, transmission points, downlink transmitting apparatuses, uplink receiving apparatuses, groups of transmitting antennas, groups of transmitting antenna ports, component carriers, eNodeBs) or transmitting stations equivalent to the base station apparatuses. In this cellular configuration, improvements in frequency usage efficiency can be brought about by using the same frequency in neighboring cells or sectors.

In recent years, significant improvements in throughput have been made possible by technologies such as MIMO (multiple-input and multiple-output) and multilevel modulation. Further, in a next-generation mobile communication system, there has been a demand for further improvements in throughput. Meanwhile, in view of overall communication speeds, reduction in delay of communication through reductions of delays attributed to communication access time, procedures between communication apparatuses, and the like, as well as improvement in bit rate, is an important technology. For example, in a case where a high bit rate is not required but instantaneous communication is needed, e.g. in the case of a type of MTC (Machine Type Communication), there has been a demand for reduction in delay of communication, as delays exert great influence. NPL 1 describes reduction in delay of communication. CITATION LIST

### Non Patent Literature

NPL 1: “Study on Latency reduction for LTE”, 3GPP TSG RAN Meeting #67, March 2015.

### SUMMARY OF INVENTION

### Technical Problem

High reliability of communication is a vital component of reduction in delay of communication. However, NPL 1 fails to describe specific means for achieving reduction in delay of communication. The present invention has been made in view of such circumstances and has as an object to provide a base station apparatus, a terminal apparatus, and a communication method that make it possible to achieve reduction in delay of communication.

### Solution to Problem

In order to solve the problems described above, a base station apparatus, a terminal apparatus, and a communication method according to the present invention are configured as follows:

(1) A base station apparatus of the present invention is a base station apparatus for performing communication with a terminal apparatus under first and second communication schemes differing in allowable delay time from each other, the base station apparatus notifying the terminal apparatus of pre-scheduling information including information indicating a plurality of resource candidates that are used in the first communication scheme, the base station apparatus entering a receiving operation of the first communication scheme in a resource indicated by the plurality of resource candidates.

(2) Further, a base station apparatus of the present invention is the base station apparatus described in (1) above, wherein the base station apparatus incorporates, into the pre-scheduling information, information indicating an order of priority of the plurality of resource candidates.

(3) Further, a base station apparatus of the present invention is the base station apparatus described in (1) or (2) above, wherein the base station apparatus incorporates, into the pre-scheduling information, information associated with a demodulation reference signal that the terminal apparatus transmits.

(4) Further, a base station apparatus of the present invention is the base station apparatus described in (1) above, wherein in conformity with a request from the terminal apparatus, the base station apparatus notifies the terminal apparatus of information that reconfigures the pre-scheduling information.

(5) Further, a base station apparatus of the present invention is the base station apparatus described in (1) above, wherein the pre-scheduling information includes information indicating a period of time during which the terminal apparatus is permitted communication based on the first communication scheme, and the base station apparatus enters the receiving operation of the first communication scheme in the period of time.

(6) Further, a base station apparatus of the present invention is the base station apparatus described in (1) above, wherein in a case where the base station apparatus performs communication with a plurality of terminal apparatuses including the terminal apparatus under the first communication scheme, the base station apparatus notifies the plurality of terminal apparatuses of the pre-scheduling information in common.

(7) Further, a terminal apparatus of the present invention is a terminal apparatus for performing communication with a base station apparatus under first and second communication schemes differing in allowable delay time from each other, the terminal apparatus acquiring pre-scheduling information of which the base station notifies the terminal apparatus, the pre-scheduling information including information indicating a plurality of resource candidates that are used in the first communication scheme, the terminal apparatus using at least one resource of the plurality of resource candidates in a case of performing communication under the first communication scheme.

(8) Further, a terminal apparatus of the present invention is the terminal apparatus described in (7) above, wherein in a case where the terminal apparatus performs communication under the first communication scheme, the terminal apparatus selects different resources from among the plurality of resource candidates and uses the different resources for a first-transmit signal and a retransmit signal, respectively.

(9) Further, a communication method of the present invention is a communication method by which a base station apparatus performs communication with a terminal apparatus under first and second communication schemes differing in allowable delay time from each other, including the steps of: notifying the terminal apparatus of pre-scheduling information including information indicating a plurality of resource candidates that are used in the first communication scheme; and entering a receiving operation of the first communication scheme in a resource indicated by the plurality of resource candidates.

(10) Further, a communication method of the present invention is a communication method by which a terminal apparatus performs communication with a base station apparatus under first and second communication schemes differing in allowable delay time from each other, comprising the steps of: acquiring pre-scheduling information of which the base station notifies the terminal apparatus, the pre-scheduling information including information indicating a plurality of resource candidates that are used in the first communication scheme; and using at least one resource of the plurality of resource candidates in a case of performing communication under the first communication scheme.

### Advantageous Effects of Invention

The base station apparatus, the terminal apparatus, and the communication method of the present invention make it possible to achieve communication with reduced delay and can therefore contribute to the enhanced efficiency of the whole system, including reduced overhead.

### BRIEF DESCRIPTION OF DRAWINGS

FIG. 1 is a diagram showing an example of a communication system according to the present embodiment.

FIG. 2 is a sequence chart showing an example of communication according to the present embodiment.

FIG. 3 is a block diagram showing an example configuration of a base station apparatus according to the present embodiment.

FIG. 4 is a block diagram showing an example configuration of a terminal apparatus according to the present embodiment.

### DESCRIPTION OF EMBODIMENTS

A communication system according to the present embodiment includes a base station apparatus (transmitting apparatus, cell, transmitting point, group of transmitting antennas, group of transmitting antenna ports, component carrier, eNodeB) and a terminal apparatus (terminal, mobile terminal, receiving point, receiving terminal, receiving apparatus, group of receiving antennas, group of receiving antenna ports, UE).

In the present embodiment, “X/Y” encompasses the meaning of “X or Y”. In the present embodiment, “X/Y” encompasses the meaning of “X and Y”. In the present embodiment, “X/Y” encompasses the meaning of “X and/or Y”.

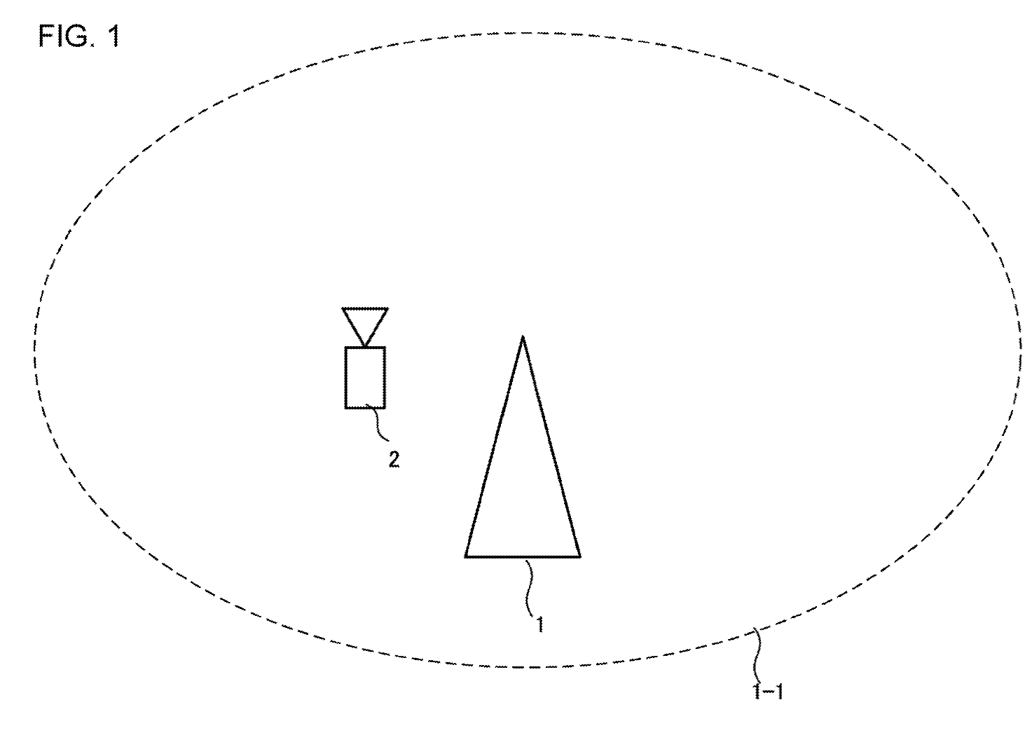

FIG. 1 is a diagram showing an example of the communication system according to the present embodiment. As shown in FIG. 1, the communication system according to the present embodiment includes a base station apparatus 1 and a terminal apparatus 2. Further, a coverage 1-1 is a range (communication area) within which the base station apparatus 1 is connectable to the terminal apparatus.

In FIG. 1, the uplink physical channels listed below are used in an uplink wireless communication from the terminal apparatus 2 to the base station apparatus 1. The uplink physical channels are used to transmit information outputted from a higher layer.
PUCCH (Physical Uplink Control Channel)
PUCCH (Physical Uplink Shared Channel)
PRACH (Physical Random Access Channel)

The PUCCH is used to transmit uplink control information (UCI). Note here that the uplink control information includes an ACK (a positive acknowledgement) or a NACK (a negative acknowledgment) to downlink data (downlink transport block, downlink-shared channel: DL-SCH). The ACK/NACK to the downlink data is also referred to as “HARQ-ACK” or “HARQ feedback”.

Further, the uplink control information includes channel state information (CSI) on the downlink. Further, the uplink control information includes a scheduling request (SR) that is used to request uplink-shaped channel (UL-SCH) resources. The channel state information corresponds to a rank indicator RI that indicates a preferred spatial multiplexing order, a precoding matrix indicator PMI that indicates a preferred precoder, a channel quality indicator CQI that indicates a preferred transmission rate, and the like.

The channel quality indicator CQI (hereinafter referred to as “CQI value”) can be a preferred modulation scheme (e.g. QPSK, 16QAM, 64QAM, 256QAM, or the like) in a predetermined band (described in detail later) or a coding rate. The CQI value can be an index (CQI index) determined by the modulation scheme or the coding rate. The CQI value can be one determined in advance by the system.

It should be noted that the rank indicator and the precoding quality indicator can be ones determined in advance by the system. The rank indicator and the precoding matrix indicator can be indices determined by the spatial multiplexing order and precoding matrix information, respectively. It should be noted that the values of the rank indicator, the precoding matrix indicator, and the channel quality indicator CQI are collectively referred to as “CSI values”.

The PUSCH is used to transmit uplink data (uplink transport block, UL-SCH). Further, the PUSCH may be used together with the uplink data to transmit the ACK/NACK and/or the channel state information. Further, the PUSCH may be used to transmit only the uplink control information.

Further, the PUSCH is used to transmit an RRC message. The RRC message is information/signal that is processed in a radio resource control (RRC) layer. Further, the PUSCH is used to transmit an MAC CE (control element). Note here that the MAC CE is information/signal that is processed (transmitted) in a medium access control (MAC) layer.

For example, a power headroom may be included in the MAC CE and reported via the PUSCH. That is, a field in the MAC CE may be used to indicate a level of the power headroom.

The PRACH is used to transmit a random access preamble.

Further, in the uplink wireless communication, an uplink reference signal (UL RS) is used as an uplink physical signal. The uplink physical signal is not used to transmit the information outputted from the higher layer, but is used by a physical layer. Note here that the uplink reference signal includes a DMRS (demodulation reference signal) and an SRS (sounding reference signal).

The DMRS is associated with the transmission of the PUSCH or the PUCCH. For example, the base station apparatus 1 uses the DMRS to make a channel correction to the PUSCH or the PUCCH. The SRS is not associated with the transmission of the PUSCH or the PUCCH. For example, the base station apparatus 1 uses the SRS to measure an uplink channel state.

In FIG. 1, the downlink physical channels listed below are used in a downlink wireless communication from the base station apparatus 1 to the terminal apparatus 2. The downlink physical channels are used to transmit information outputted from a higher layer.
PBCH (Physical Broadcast Channel: broadcast channel)
PCFICH (Physical Control Format Indicator Channel: control format indicator channel)
PHICH (Physical Hybrid automatic repeat request Indicator Channel: HARQ indicator channel)
PDCCH (Physical Downlink Control Channel: downlink control channel)
EPDCCH (Enhanced Physical Downlink Control Channel: enhanced downlink channel)
PDSCH (Physical Downlink Shared Channel: downlink shared channel)

The PBCH is used to broadcast a master information block (MIB, broadcast channel: BCH) that is commonly used by the terminal apparatuses. The PCFICH is used to transmit information indicating a region (e.g. the number of OFDM symbols) that is used in the transmission of the PDCCH.

The PHICH is used to transmit an ACK/NACK to uplink data (transport block, code word) that the base station apparatus 1 received. That is, the PHICH is used to transmit an HARQ indicator (HARQ feedback) indicating the ACK/NACK to the uplink data. Further, the ACK/NACK is also referred to as “HARQ-ACK”. The terminal apparatus 2 notifies the higher layer of the received ACK/NACK. The ACK/NACK is an ACK that indicates successful reception, a NACK that indicates failed reception, or a DTX that indicates there was no corresponding data. Further, in the absence of a PHICH corresponding to the uplink data, the terminal apparatus 2 notifies the higher layer of the ACK.

The PDCCH and the EPDCCH are used to transmit downlink control information (DCI). Note here that a plurality of DCI formats are defined for the transmission of the downlink control information. That is, a field for the downlink control information is defined in a DCI formant and mapped to an information bit.

For example, as a DCI format for the downlink, a DCI format 1A that is used in the scheduling of one PDSCH (transmission of one downlink transport block) in one cell is defined.

For example, the DCI format for the downlink includes information pertaining to the allocation of PDSCH resources, information pertaining to an MCS (modulation and coding scheme) for the PDSCH, and downlink control information such as a TPC command for the PUCCH. Note here that the DCI format for the downlink is also referred to as “downlink grant (or downlink assignment)”.

Further, for example, as a DCI format for the uplink, a DCI format 0 that is used in the scheduling of one PUSCH (transmission of one uplink transport block) in one cell is defined.

For example, the DCI format for the uplink includes information pertaining to the allocation of PUSCH resources, information pertaining to an MCS for the PUSCH, and uplink control information such as a TPC command for the PUSCH. The DCI format for the uplink is also referred to as “uplink grant (or uplink assignment)”.

Further, the DCI format for the uplink can be used to request (CSI request) downlink channel state information (CSI; also referred to as “reception quality information”). The channel state information corresponds to a rank indicator RI that indicates a preferred spatial multiplexing order, a precoding matrix indicator PMI that indicates a preferred precoder, a channel quality indicator CQI that indicates a preferred transmission rate, a precoding type indicator PTI, and the like.

Further, the DCI format for the uplink can be used to configure the settings for indicating an uplink resource to which map a channel state information report (CSI feedback report) that the terminal apparatus feeds back to the base station apparatus. For example, the channel state information report can be used to configure the settings for indicating an uplink resource through which to periodically report channel state information (periodic CSI). The channel state information report can be used to configure the mode settings (CSI report mode) for periodically reporting channel state information.

For example, the channel state information report can be used to configure the settings for indicating an uplink resource through which to report aperiodic channel state information (aperiodic CSI). The channel state information report can be used to configure the mode settings (CSI report mode) for aperiodically reporting channel state information. The base station apparatus can configure either the periodic channel state information report or the aperiodic channel state information report. Further, the base station apparatus can configure both the periodic channel state information report and the aperiodic channel state information report.

Further, the DCI format for the uplink can be used to configure the settings for indicating the type of channel state information report that the terminal apparatus feeds back to the base station apparatus. Examples of the type of channel state information report include broadband CSI (e.g. wideband CQI), narrowband CSI (e.g. subband CQI), and the like.

In a case where the PDSCH resources have been scheduled using the downlink assignment, the terminal apparatus receives the downlink data via the PDSCH thus scheduled. Further, in a case where the PUSCH resources have been scheduled using the uplink grant, the terminal apparatus transmits the uplink data and/or the uplink control information via the PUSCH thus scheduled.

The PDSCH is used to transmit downlink data (downlink transport block, DL-SCH). Further, the PDSCH is used to transmit a system information block type 1 message. The system information block type 1 message is cell-specific information.

Further, the PDSCH is used to transmit a system information message. The system information message includes a system information block X other than the system information block type 1. The system information message is cell-specific information.

Further, the PDSCH is used to transmit an RRC message. Note here that an RRC message that is transmitted from the base station apparatus may be shared by the plurality of terminal apparatuses in the cell. Further, an RRC message that is transmitted from the base station apparatus 1 may be a dedicated message (also referred to as “dedicated signaling”) for a terminal apparatus 2. That is, UE-specific information is transmitted using a dedicated message for a terminal apparatus. Further, the PDSCH is used to transmit an MAC CE.

Note here that the RRC message and/or the MAC CE is/are also referred to as “higher layer signaling”.

Further, the PDSCH can be used to request downlink channel state information. Further, the PDSCH can be used to transmit an uplink resource to which to map a channel state information report (CSI feedback report) that the terminal apparatus feeds back to the base station apparatus. For example, the channel state information report can be used to configure the settings for indicating an uplink resource through which to periodically report channel state information (periodic CSI). The channel state information report can be used to configure the mode settings (CSI report mode) for periodically reporting channel state information.

Examples of the type of downlink channel state information report include broadband CSI (e.g. wideband CSI) and narrowband CSI (e.g. subband CSI). The broadband CSI calculates one piece of channel state information for the system band of the cell. The narrowband CSI divides the system band into predetermined units and calculates one piece of channel state information for the division.

Further, in the downlink wireless communication, a synchronization signal (SS) and a downlink reference signal (DL RS) are used as downlink physical signals. The downlink physical signals are not used to transmit the information outputted from the higher layer, but is used by a physical layer.

The synchronization signal is used for the terminal apparatus to synchronize a downlink frequency domain and a downlink time domain with each other. Further, the downlink reference signal is used for the terminal apparatus to make a channel correction to a downlink physical channel. For example, the downlink reference signal is used for the terminal apparatus to calculate downlink channel state information.

Note here that the downlink reference signal includes a CRS (cell-specific reference signal), a URS (UE-specific reference signal) associated with the PDSCH, a DMRS (demodulation reference signal) associated with the EPDCCH, an NZP CSI-RS (non-zero power channel state information-reference signal), and a ZP CSI-RS (zero power channel state information-reference signal).

The CRS is transmitted over the full bandwidth of subframes, and are used to demodulate the PBCH/PDCCH/PHICH/PCFICH/PDSCH. The URS associated with the PDSCH is transmitted over a subframe and a band that are used in the transmission of the PDSCH with which the URS is associated, and is used to demodulate the PDSCH with which the URS is associated.

The DMRS associated with the EPDCCH is transmitted over a subframe and a band that are used to transmit the EPDCCH with which the DMRS is associated. The DMRS is used to demodulate the EPDCCH with which the DMRS is associated.

NZP CSI-RS resources are configured by the base station apparatus 1. For example, the terminal apparatus 2 performs signal measurements (channel measurements) with reference to the NZP CSI-RS. The ZP CSI-RS resources are configured by the base station apparatus 1. The base station apparatus 1 transmits the ZP CSI-RS with zero output. For example, the terminal apparatus 2 performs interference measurements in the resources to which the NZP CSI-RS corresponds.

An MBSFN (multimedia-broadcast single-frequency network or multicast-service single-frequency network) RS is transmitted over the full bandwidth of subframes that are used to transmit a PMCH. The MBSFN RS is used to demodulate the PMCH. The PMCH is transmitted through an antenna port that is used to transmit the MBSFN RS.

Note here that the downlink physical channels and the downlink physical signals are also collectively referred to as “downlink signals”. Further, the uplink physical channels and the uplink physical signals are also collectively referred to as “uplink signals”. Further, the downlink physical channels and the uplink physical channels are also collectively referred to as “physical channels”. Further, the downlink physical signals and the uplink physical signals are also collectively referred to as “physical signals”.

Further, the BCH, the UL-SCH, and the DL-SCH are transport channels. A channel that is used in the MAC layer is referred to as “transport channel”. Further, a unit of the transport channel that is used in the MAC layer is also referred to as “transport block (TB)” or “MAC PDU (protocol data unit)”. The transport block is a unit of data that the MAC layer delivers to a physical layer. In the physical layer, the transport block is mapped to a code word, and a coding process and the like is performed for each code word.

Prior to communication with a terminal apparatus, a base station according to the present embodiment notifies the terminal apparatus of a plurality of resource candidates that the terminal apparatus uses. Upon generation of data (traffic) to be transmitted to the terminal apparatus, the terminal apparatus selects one resource from among the plurality of resource candidates of which the base station apparatus notified the terminal apparatus. Then, the terminal apparatus can perform data transmission to the base station apparatus through the resource thus selected. Since, in the conventional LTE, a terminal apparatus has requested (scheduling request) a base station apparatus for a resource that the terminal apparatus uses in communication, a method of the present invention makes it possible to significantly reduce the time to the start of data transmission.

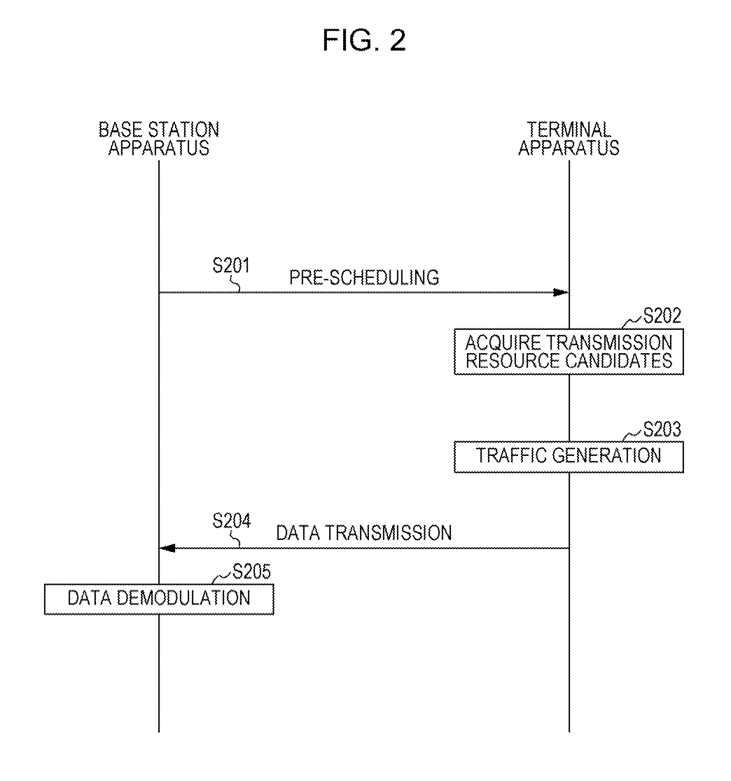

FIG. 2 is a sequence chart showing an example of communication according to the present embodiment. First, the base station apparatus performs pre-scheduling by which the base station apparatus notifies the terminal apparatus of a plurality of resource candidates that the terminal apparatus uses (step S201). In the following, a communication method by which the terminal apparatus transmits a signal on according to the pre-scheduling is also referred to as “low-latency communication scheme (first communication scheme)”. Meanwhile, a communication method by which the terminal apparatus transmits a signal in conformity with a conventional scheduling request is also referred to as “normal communication scheme (second communication scheme)”. Note here that the low-latency communication scheme allows for a shorter delay time than the normal communication scheme. In other words, it can be said that the terminal apparatus performs communication with the base station apparatus under two communication methods differing in allowable delay time from each other. The following description deals mainly with a case where the base station apparatus and the terminal apparatus perform communication under the first communication scheme.

The type and number of the plurality of resource candidates of which the base station apparatus notifies the terminal apparatus are not limited to any type and number. For example, the base station apparatus can notify the terminal apparatus of, as pre-scheduling information, information associated with a plurality of resource blocks or frequency resources typified by subbands. Further, the base station apparatus can notify, as the pre-scheduling information, information associated with time resources typified by a slot number, a subframe number, and a system frame number. Further, the base station apparatus can notify, as the pre-scheduling information, information associated with space resources typified by an antenna port number. Further, the base station apparatus may notify the terminal apparatus of one or more type of information pertaining to time, frequency, and space resources.

By incorporating, into the pre-scheduling information, information indicating to the terminal apparatus the plurality of resource candidates, the base station apparatus allows the terminal apparatus to obtain a plurality of choices of resources that are available for low-delay communication. By selecting a resource from among the plurality of resource candidates for use in low-delay communication, the terminal apparatus can reduce the probability of a collision between a signal that the terminal apparatus transmitted on the basis of low-delay communication and a signal that another terminal apparatus transmitted on the basis of low-delay communication. Further, by incorporating the plurality of resource candidates into the pre-scheduling information, the base station apparatus can reduce the frequency of notification of the pre-scheduling information to the terminal apparatus.

In a case where a plurality of terminal apparatuses including another terminal apparatus are connected to the base station apparatus, the base station apparatus can notify the plurality of terminal apparatuses of the pre-scheduling information in common. This control allows the base station apparatus to broadcast the pre-scheduling information to the plurality of terminal apparatuses connected to the base station apparatus, thus making it possible to reduce the overhead involved in the notification of the pre-scheduling information. Further, since the plurality of resource candidates are described in the pre-scheduling information, the plurality of terminal apparatuses have room for selecting different resources, respectively, even when having received the pre-scheduling information in common. Therefore, the plurality of terminal apparatuses can reduce the probability of a collision between signals that they transmit respectively in a case where the plurality of terminal apparatuses perform low-delay communication.

In a case where a plurality of terminal apparatuses including another terminal apparatus are connected to the base station apparatus, the base station apparatus can notify the plurality of terminal apparatuses of different pieces of pre-scheduling information, respectively. The base station apparatus can incorporate, into the different pieces of pre-scheduling information, pieces of information each indicating a different plurality of resource candidates. Further, the station apparatus can incorporate, into the different pieces of pre-scheduling information, pieces of information partly indicating a common plurality of resource candidates. This control makes the plurality of terminal apparatuses more likely to perform low-delay communication through different resources, respectively, thus making it possible to reduce the probability of a collision between signals that they transmit respectively in a case where the plurality of terminal apparatuses perform low-delay communication.

In addition to being able to incorporate the plurality of resource candidates as the pre-scheduling information, the base station apparatus can incorporate, into the pre-scheduling information, information indicating an order of priority of the plurality of resource candidates. It should be noted that the information indicating the order of priority of the plurality of resource candidates may be agreed upon in advance between the base station and the terminal apparatus instead of being incorporated into the pre-scheduling information.

Further, the base station apparatus can incorporate, into the pre-scheduling information, information associated with code resources. A terminal apparatus according to the present embodiment can perform low-delay communication in conformity with code division multiple access (CDMA). For example, the terminal apparatus can use a pseudo-noise (PN) sequence to spread data to be transmitted and transmit the data to the base station apparatus. At this point in time, the base station apparatus can incorporate, into the pre-scheduling information, information such as a formula for generation of a PN sequence, an initial value, and a spreading ratio. It should be noted that the terminal apparatus according to the present embodiment can use a code sequence other than a PN sequence in low-delay communication. For example, the terminal apparatus can use orthogonal spreading codes typified by a Walsh code and an orthogonal variable spreading factor (OVSF) code and a spreading code calculated from an orthogonal base such as a DFT matrix, and the base station apparatus can incorporate, into the pre-scheduling information, information pertaining to a code sequence other than a PN sequence.

Further, the base station apparatus can incorporate, into the pre-scheduling information, part of information that is needed for low-delay communication with the terminal apparatus. The base station apparatus can incorporate, into the pre-scheduling information, the information that is needed for low-delay communication with the terminal apparatus. Examples of the information include a transport block size, an MCS, the number of transmission streams, the number of code words, precoding information, a DMRS signal sequence, an amount of phase rotation that is applied to the DMRS signal sequence, and the like.

The base station apparatus can incorporate the pre-scheduling information into a signal to be transmitted through the PBCH or the PDCCH (or EPDCCH). Further, the base station apparatus can transmit the pre-scheduling information in higher layer signaling such as RRC signaling.

Next, on the basis of the pre-scheduling information of which the base station apparatus notifies the terminal apparatus, the terminal apparatus acquires the resource candidates that the terminal apparatus uses in performing low-delay communication (step S202). The terminal apparatus can more randomly select a resource from among the plurality of resource candidates included in the pre-scheduling information. Further, in a case where the pre-scheduling information includes information indicating an order of priority of the plurality of resource candidates, the terminal apparatus can select a resources from among the plurality of resource candidates on the basis of the order of priority.

Next, when data (traffic) to be transmitted to the base station apparatus is generated in the terminal apparatus (step S203), the terminal apparatus transmits the data to the base station apparatus through one or more of the resource candidates acquired in step S203 (step S204).

In step S201, with respect to the plurality of resources of which the base station apparatus notified the terminal apparatus, the base station apparatus can enter a receiving operation for demodulating a signal transmitted under the low-latency communication scheme. Since a signal that the terminal apparatus transmits in low-delay communication is transmitted through one or more of the plurality of resources of which the base station apparatus notified the terminal apparatus in step S201, the receiving operation with respect to the plurality of resources of which the base station apparatus notified the terminal apparatus allows the base station apparatus to demodulate the signal that the terminal apparatus transmitted (step S204).

The base station apparatus can reconfigure the pre-scheduling information of which the base station apparatus notified the terminal apparatus. The base station apparatus can periodically transmit the pre-scheduling information through the PDCCH. Further, the base station apparatus can also aperiodically transmit the pre-scheduling information through the PDCCH. In a case where the base station apparatus reconfigures the pre-scheduling information, the base station apparatus may notify all of the pre-scheduling information again or may notify information indicating a difference from the pre-scheduling information notified most recently. A trigger at which the base station apparatus aperiodically transmits the pre-scheduling information can be applied by the base station apparatus on the basis of, for example, the reception quality of a signal transmitted from the terminal apparatus on the basis of low-delay communication. Alternatively, the terminal apparatus may apply the trigger to the base station apparatus on the basis of the reception quality of a signal the terminal apparatus transmitted on the basis of low-delay communication. For example, the terminal apparatus can apply the trigger to the base station apparatus in a case where the terminal apparatus has determined that there are many retransmission requests from the base station apparatus.

The terminal apparatus can perform low-delay communication through one or more of the plurality of resources of which the base station apparatus has notified the terminal apparatus as the pre-scheduling information. The terminal apparatus can perform low-delay communication by randomly selecting a resource from among the plurality of resources. Further, the terminal apparatus can select, on the basis of an error having occurred in low-delay communication, a resource that is used in low-delay communication. Let suppose, for example, a case where the terminal apparatus has acquired two resources, namely a first resource and a second resource, from the pre-scheduling information. Let it be assumed here that a transmission request has been sent from the base station apparatus due to an error having occurred in low-delay communication that the terminal apparatus performs through the first resource. In this case, for the retransmission attributed to the error having occurred in low-delay communication, the terminal apparatus can use a resource (second resource) that is different from the resource (first resource) used in the first transmission.

The terminal apparatus can individually determine whether to perform low-delay communication through a primary cell (Pcell) or a secondary cell (Scell) or switch between Pcell and Scell to perform low-delay communication. The base station apparatus can incorporate, as the pre-scheduling information, whether to permit the terminal apparatus low-delay communication through Pcell or permit the terminal apparatus low-delay communication through Scell. Of course, the bases station apparatus can incorporate, as the pre-scheduling information, information indicating that the terminal apparatus is prohibited from performing low-delay communication through Pcell or information indicating that the terminal apparatus is prohibited from performing low-delay communication through Scell.

The base station apparatus can incorporate, as the pre-scheduling information, information indicating a period of time during which the terminal apparatus is permitted low-delay communication. The terminal apparatus can only perform low-delay communication during the period of time described in the pre-scheduling information. In the period of time during which the terminal apparatus is permitted low-delay communication, which was notified as the pre-scheduling information, the base station apparatus can notify the terminal apparatus of information that withdraws the permission for low-delay communication. In a case where the terminal apparatus has acquired the information that withdraws the permission for low-delay communication, the terminal apparatus can stop the start of low-delay communication. In this case, in a period during which low-delay communication is not permitted, the base station apparatus can stop a receiving operation with respect to the plurality of resources of which the base station apparatus notified the terminal apparatus.

Further, a terminal apparatus according to the present embodiment can perform low-delay communication according to semi-persistent scheduling (SPS). In SPS, the base station apparatus can notify the terminal apparatus in advance through the PDCCH of periodic resources for uplink communication. Further, the base station apparatus can periodically notify the terminal apparatus through the PDCCH of a resource that is allocated to the terminal apparatus in advance. The terminal apparatus can perform low-delay communication through a resource allocated by the base station apparatus in advance. In conventional SPS, no retransmission is performed even if an error occurs in communication with a terminal apparatus. A terminal apparatus according to the present embodiment allows the base station apparatus to send a retransmission request to the terminal apparatus in a case where an error has occurred in communication based on SPS. In conformity with the retransmission request sent from the base station apparatus, the terminal apparatus can retransmit data associated with the retransmission request. The terminal apparatus may retransmit the data through the resource used at the time of the first transmission or through a different resource. Further, the terminal apparatus may perform the retransmission under the normal communication scheme (second communication scheme) instead of the low-latency communication scheme (first communication scheme). It should be noted that one or more frequency-domain resources may be notified from the base station.

Further, in the conventional SPS, the value representing an amount of cyclic shift in uplink DMRS by downlink control information (DCI) is set to ‘000’, the TPC command is set to ‘00’, and the MSB of a region indicating an MCS is set to ‘0’. By being set to these values, the terminal apparatus can recognize not dynamic scheduling but SPS has been set. Meanwhile, in a case where a terminal apparatus according to the present embodiment performs low-delay communication on the basis of SPS, the base station apparatus can incorporate, into the pre-scheduling information, information pertaining to the DMRS that the terminal apparatus transmits. That is, it becomes possible to set the value of the DMRS to a value other than ‘000’. With this, while, in the conventional SPS, the amount of phase rotation that a terminal apparatus applies to a DMRS is uniquely fixed, a method according to the present embodiment allows the terminal apparatus to apply, to a DMRS signal sequence, an amount of phase rotation that is different from that which is applied by another terminal apparatus, thus making it possible to enhance the orthogonality of DMRSs that are transmitted from a plurality of terminal apparatuses. It should be noted that, in the case of the conventional SPS, a case of having decoded DCI addressed to another terminal apparatus and succeeded in a CRC ends up in continued use of resources on a long-term basis by SPS. This problem is addressed by putting restrictions on cyclic shifts as described above so that SPS is not mistakenly activated even in a case of having decoded DCI addressed to another terminal apparatus and succeeded in a CRC. However, low-delay transmission does not secure resources on a long-term basis, thus making it possible to arbitrarily set an amount of cyclic shift in DMRS.

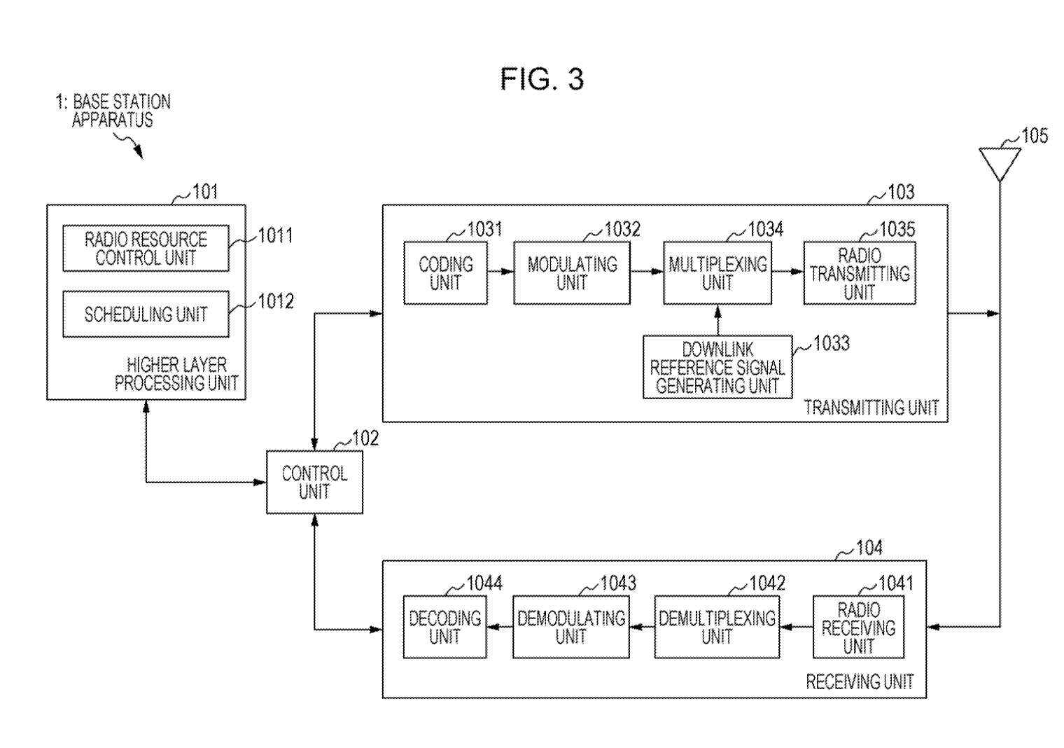

FIG. 3 is a block diagram schematically showing a configuration of a base station apparatus 1 according to the present embodiment. As shown in FIG. 3, the base station apparatus 1 includes a higher layer processing unit (higher layer processing step) 101, a control unit (control step) 102, a transmitting unit (transmitting step) 103, a receiving unit (receiving step) 104, and a transmitting and receiving antenna 105. Further, the higher layer processing unit 101 includes a radio resource control unit (radio resource control step) 1011 and a scheduling unit (scheduling step) 1012. Further, the transmitting unit 103 includes a coding unit (coding step) 1031, a modulating unit (modulating step) 1032, a downlink reference signal generating unit (downlink reference signal generating step) 1033, a multiplexing unit (multiplexing step) 1034, and a radio transmitting unit (radio transmitting step) 1035. Further, the receiving unit 104 includes a radio receiving unit (radio receiving step) 1041, a demultiplexing unit (demultiplexing step) 1042, a demodulating unit (demodulating step) 1043, and a decoding unit (decoding step) 1044.

The higher layer processing unit 101 processes a medium access control (MAC) layer, a packet data convergence protocol (PDCP) layer, a radio link control (RLC) layer, and a radio resource control (RRC) layer. Further, the higher layer processing unit 101 generates information that is needed to control the transmitting unit 103 and the receiving unit 104, and outputs the information to the control unit 102.

The higher layer processing unit 101 receives information pertaining to a terminal apparatus, such as a terminal apparatus function (UE capability), from the terminal apparatus. In other words, the terminal apparatus transmits its function to the base station apparatus by means of higher layer signaling.

It should be noted that, in the following description, the information pertaining to a terminal apparatus includes information indicating whether the terminal apparatus supports a predetermined function or information indicating completion of introduction and testing of the predetermined function by the terminal apparatus. It should be noted that, in the following description, whether to support a predetermined function includes whether introduction and testing of the predetermined function are completed.

For example, in a case where a terminal apparatus supports a predetermined function, the terminal apparatus transmits information (parameter) indicating whether to support the predetermined function. In a case where a terminal apparatus does not support a predetermined function, the terminal apparatus does not transmit information (parameter) indicating whether to support the predetermined function. That is, whether to support the predetermined function is notified by whether to transmit information (parameter) indicating whether to support the predetermined function. It should be noted that the information (parameter) indicating whether to support a predetermined function may be notified by using one bit of 1 or 0.

The radio resource control unit 1011 generates downlink data (transport block), system information, an RRC message, an MAC CE, and the like that are allocated on a downlink PDSCH, or acquires these pieces of information from a higher node. The radio resource control unit 1011 outputs the downlink data to the transmitting unit 103 and outputs the other pieces of information to the control unit 102. Further, the radio resource control unit 1011 manages various types of configuration information of a terminal apparatus.

The scheduling unit 1012 determines frequencies and subframes to which physical channels (PDSCH and PUSCH) are allocated, code rates and modulation schemes (or MCSs) of the physical channels (PDSCH and PUSCH), transmission powers, and the like. The scheduling unit 1012 outputs the information thus determined to the control unit 102.

The scheduling unit 1012 generates, on the basis of a scheduling result, information that is used in the scheduling of the physical channels (PDSCH and PUSCH). The scheduling unit 1012 outputs the information thus generated to the control unit 102.

The control unit 102 generates, on the basis of the information inputted from the higher layer processing unit 101, control signals in accordance with which the transmitting unit 103 and the receiving unit 104 are controlled. The control unit 102 generates downlink control information on the basis of the information inputted from the higher layer processing unit 101 and outputs the downlink control information to the transmitting unit 103.

In accordance with the control signal inputted from the control unit 102, the transmitting unit 103 generates a downlink reference signal, codes and modulates the HARQ indicator, the downlink control information, and the downlink data, which were inputted from the higher layer processing unit 101, multiplexes the PHICH, the PDCCH, the EPDCCH, the PDSCH, and the downlink reference signal, and transmits the multiplexed signals to the terminal apparatus 2 via the transmitting and receiving antenna 105.

The coding unit 1031 codes the HARQ indicator, the downlink control information, and the downlink data, which were inputted from the higher layer processing unit 101, under a predetermined coding scheme such as block coding, convolutional coding, or turbo coding or under a coding scheme determined by the radio resource control unit 1011. The modulating unit 1032 receives coding bits from the coding unit 1031 and modulates the coding bits under a predetermined modulation scheme such as BPSK (binary phase shift keying), QPSK (quadrature phase shift keying), 16QAM (quadrature amplitude modulation), 64QAM, or 256QAM or under a modulation scheme determined by the radio resource control unit 1011.

On the basis of a physical identifier (PCI, cell ID) or the like for identifying the base station apparatus 1, the downlink reference signal generating unit 1033 generates, as the downlink reference signal, a sequence known by the terminal apparatus 2 that is determined according to a predetermined rule.

The multiplexing unit 1034 multiplexes a modulation symbol of each channel modulated, the downlink reference signal thus generated, and the downlink control information thus generated. That is, the multiplexing unit 1034 allocates the modulation symbol of each channel modulated, the downlink reference signal, and the downlink control information on a resource element.

The radio transmitting unit 1035 generates an OFDM symbol by performing inverse fast Fourier transform (IFFT) on the modulation symbols and the like thus multiplexed, generates a baseband digital signal by appending a cycle prefix (CP) to the OFDM symbol, converts the baseband digital signal into an analog signal, eliminates an excess frequency component by filtering, performs up conversion into a carrier frequency, performs power amplification, outputs the analog signal to the transmitting and receiving antenna 105, and transmits the analog signal.

In accordance with the control signal inputted from the control unit 102, the receiving unit 104 demultiplexes, demodulates, and decodes a received signal received from the terminal apparatus 2 via the transmitting and receiving antenna 105 and outputs decoded information to the higher layer processing unit 101.

The radio receiving unit 1041 receives an uplink signal via the transmitting and receiving antenna 105, converts the uplink signal into a baseband signal by performing down conversion, eliminates an unnecessary frequency component, controls an amplification level so that a signal level is appropriately maintained, performs orthogonal demodulation on the basis of an in-phase component and an orthogonal component of the received signal, and converts the orthogonally-demodulated analog signal into a digital signal.

The radio receiving unit 1041 eliminates, from the digital signal thus converted, a portion corresponding to the CP. The radio receiving unit 1041 performs fast Fourier transform (FFT) on the signal from which the CP has been eliminated, extracts a frequency-domain signal, and outputs the frequency-domain signal to the demultiplexing unit 1042.

The demultiplexing unit 1042 demultiplexes the signal inputted from the radio receiving unit 1041 into signals such as the PUCCH, the PUSCH, and the uplink reference signal. It should be noted that this demultiplexing is performed on the basis of radio resource allocation information included in an uplink grant determined in advance by the radio resource control unit 1011 of the base station apparatus 1 and notified to each terminal apparatus 2.

Further, the demultiplexing unit 1042 makes compensations for the channels of the PUCCH and the PUSCH. Further, the demultiplexing unit 1042 demultiplexes the uplink reference signal.

The demodulating unit 1043 performs inverse discrete Fourier transform (IDFT) on the PUSCH, acquires the modulation symbols, and performs demodulation of the received signal on each of the modulation symbols of the PUCCH and the PUSCH under a modulation scheme such as BPSK, QPSK, 16QAM, 64QAM, or 256QAM or under a modulation scheme notified in advance by the base station apparatus 1 to each terminal apparatus 2 through the uplink grant.

The decoding unit 1044 decodes the coding bits of the PUCCH and the PUSCH thus demodulated. This decoding is performed under a predetermined coding scheme and at predetermined coding rates or coding rates notified in advance by the base station apparatus 1 to the terminal apparatus 2 through the uplink grant. The decoding unit 1044 outputs the uplink data thus decoded and the uplink control information to the higher layer processing unit 101. In the case of retransmission of the PUSCH, the decoding unit 1044 performs decoding using coding bits retained in an HARQ buffer that is inputted from the higher layer processing unit 101 and the coding bits thus demodulated.

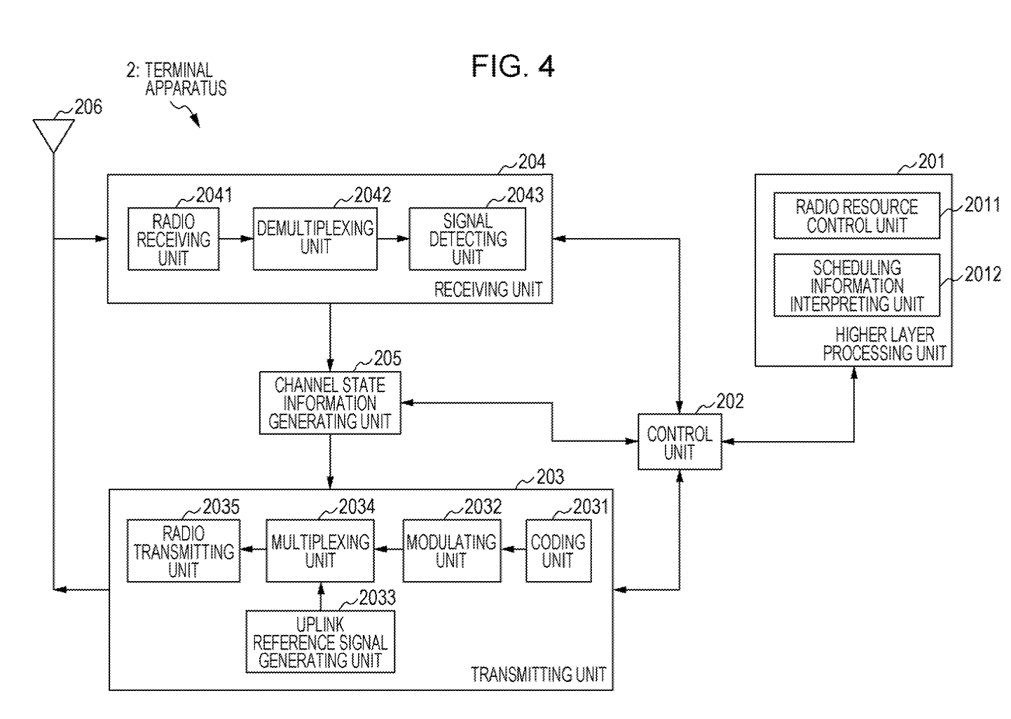

FIG. 4 is a block diagram schematically showing a configuration of a terminal apparatus 2 according to the present embodiment. As shown in FIG. 4, the terminal apparatus 2 includes a higher layer processing unit (higher layer processing step) 201, a control unit (control step) 202, a transmitting unit (transmitting step) 203, a receiving unit (receiving step) 204, a channel state information generating unit (channel state information generating step) 205, and a transmitting and receiving antenna 206. Further, the higher layer processing unit 201 includes a radio resource control unit (radio resource control step) 2011 and a scheduling information interpreting unit (scheduling information interpreting step) 2012. Further, the transmitting unit 203 includes a coding unit (coding step) 2031, a modulating unit (modulating step) 2032, an uplink reference signal generating (uplink reference signal generating step) unit 2033, a multiplexing unit (multiplexing step) 2034, and a radio transmitting unit (radio transmitting step) 2035. Further, the receiving unit 204 includes a radio receiving unit (radio receiving step) 2041, a demultiplexing unit (demultiplexing step) 2042, and a signal detecting unit (signal detecting step) 2043.

The higher layer processing unit 201 outputs, to the transmitting unit 203, uplink data (transport block) generated by a user's operation or the like. Further, the higher layer processing unit 201 processes a medium access control (MAC) layer, a packet data convergence protocol (PDCP) layer, a radio link control (RLC) layer, and a radio resource control (RRC) layer.

The higher layer processing unit 201 outputs, to the transmitting unit 203, information indicating a terminal apparatus function that the terminal apparatus 2 supports.

The radio resource control unit 2011 manages various types of configuration information of the terminal apparatus 2. Further, the radio resource control unit 2011 generates information that is allocated on each uplink channel, and outputs the information to the transmitting unit 203.

The radio resource control unit 2011 acquires configuration information pertaining to a CSI feedback transmitted from a base station apparatus and outputs the configuration information to the control unit 202.

The scheduling information interpreting unit 2012 interprets downlink control information received via the receiving unit 204 and determines scheduling information. Further, the scheduling information interpreting unit 2012 generates, on the basis of the scheduling information, control information for controlling the receiving unit 204 and the transmitting unit 203 and outputs the control information to the control unit 202.

The control unit 202 generates, on the basis of the information inputted from the higher layer processing unit 201, control signals in accordance with which the receiving unit 204, the channel state information generating unit 205, and the transmitting unit 203 are controlled. The control unit 202 outputs the control signals thus generated to the receiving unit 204, the channel state information generating unit 205, and the transmitting unit 203 to control the receiving unit 204 and the transmitting unit 203.

The control unit 202 controls the transmitting unit 203 so the CSI generated by the channel state information generating unit 205 is transmitted to the base station apparatus.

In accordance with the control signal inputted from the control unit 202, the receiving unit 204 demultiplexes, demodulates, and decodes a received signal received from the base station apparatus 1 via the transmitting and receiving antenna 206 and outputs decoded information to the higher layer processing unit 201.

The radio receiving unit 2041 receives a downlink signal via the transmitting and receiving antenna 206, converts the downlink signal into a baseband signal by performing down conversion, eliminates an unnecessary frequency component, controls an amplification level so that a signal level is appropriately maintained, performs orthogonal demodulation on the basis of an in-phase component and an orthogonal component of the received signal, and converts the orthogonally-demodulated analog signal into a digital signal.

Further, the radio receiving unit 2041 eliminates, from the digital signal thus converted, a portion corresponding to the CP, performs fast Fourier transform (FFT) on the signal from which the CP has been eliminated, and extracts a frequency-domain signal.

The demultiplexing unit 2042 demultiplexes the extracted signal into the PHICH, the PDCCH, the EPDCCH, the PDSCH, and the downlink reference signal. Further, the demultiplexing unit 2042 makes compensations for the channels of the PHICH, the PDCCH, and the EPDCCH on the basis of channel estimation values of desired signals as obtained from channel measurements, detects the downlink control information, and outputs the downlink control information to the control unit 202. Further, the control unit 202 outputs the PDSCH and the channel estimation values of the desired signals to the signal detecting unit 2043.

The signal detecting unit 2043 detects a signal with reference to the PDSCH and a channel estimation value and outputs the signal to the higher layer processing unit 201.

In accordance with the control signal inputted from the control unit 202, the transmitting unit 203 generates an uplink reference signal, codes and modulates the uplink data (transport block) inputted from the higher layer processing unit 201, multiplexes the PUCCH, the PUSCH, and the uplink reference signal thus generated, and transmits the multiplexed signals to the base station apparatus 1 via the transmitting and receiving antenna 206.

The coding unit 2031 receives uplink control information from the higher layer processing unit 201 and codes the uplink control information by convolutional coding, block coding, or the like. Further, the coding unit 2031 performs turbo coding on the basis of information that is used in the scheduling of the PUSCH.

The modulating unit 2032 receives coding bits from the coding unit 2031 and modulates the coding bits under a predetermined modulation scheme such as BPSK, QPSK, 16QAM, or 64QAM notified through the downlink control information or under a modulation scheme determined for each channel.

On the basis of a physical cell identifier (referred to as “physical cell identity: PCI”, “cell ID”, or the like), a band on which the uplink reference signal is allocated, a cyclic shift notified through an uplink grant, the values of parameters in the generation of a DMRS sequence, the uplink reference signal generating unit 2033 generates a sequence that is determined by a predetermined rule (formula).

In accordance with the control signal inputted from the control unit 202, the multiplexing unit 2034 sorts the modulation symbols of the PUSCH in parallel and then performs discrete Fourier transform (DFT) on the modulation symbols. Further, the multiplexing unit 2034 multiplexes, for each transmitting antenna port, the signals of the PUCCH and the PUSCH and the uplink reference signal thus generated. That is, the multiplexing unit 2034 allocates, on a resource element for each transmitting antenna port, the signals of the PUCCH and the PUSCH and the uplink reference signal thus generated.

The radio transmitting unit 2035 generates an SC-FDMA symbol by performing inverse fast Fourier transform (IFFT) on the signals thus multiplexed, generates a baseband digital signal by appending a CP to the SC-FDMA symbol thus generated, converts the baseband digital signal into an analog signal, eliminates an excess frequency component, performs up conversion into a carrier frequency, performs power amplification, outputs the analog signal to the transmitting and receiving antenna 206, and transmits the analog signal.

A program that runs on a base station apparatus and a terminal apparatus according to the present invention is a program that controls a CPU or the like (i.e., a program that causes a computer to function) so that the functions of the above-described embodiment of the present invention are achieved. Moreover, information that is handled by these apparatuses is temporarily accumulated in RAM during processing thereof, stored in various types of ROM and/or HDD after that, and read out by the CPU as needed for modification and/or writing. Examples of a storage medium in which the program is stored may include semiconductor media (such as ROM and nonvolatile memory cards), optical storage media (such as DVDs, MOs, MDs, CDs, and BDs), magnetic storage media (such as magnetic tapes and flexible disks). Further, not only are the functions of the embodiment described above achieved by executing the program loaded, but also the functions of the present invention may be achieved by executing processing in cooperation with an operating system or another application program on the basis of instructions from the program.

Further, the program can be distributed to the market by being stored in a portable storage medium or being transferred to a server computer connected via a network such as the Internet. In this case, a storage device of the server computer is also encompassed in the present invention. Further, one, some, or all of the base station apparatus and the terminal apparatus in the embodiment described above may be achieved as an LSI that is typically an integrated circuit. Each functional block of the receiving apparatus may separately take the form of a chip, or one, some, or all of them may be integrated into a chip. In a case where each functional block is integrated into a circuit, an integrated circuit control unit that controls them is added.

Further, the technique of circuit integration may be achieved by a dedicated circuit or a general-purpose processor, as well as an LSI. Further, in a case where a technology of integrated circuit construction alternative to LSI comes out due to the advancement of technology, it is possible to use integrated circuits based on such a technology.

It should be noted that the present invention is not limited to the embodiment described above. A terminal apparatus of the present invention is not limited to being applied to a base station apparatus, and is of course applicable to stationary or immovable electronic devices that are installed indoors or outdoors such as audiovisual equipment, kitchen appliances, cleaning and washing machines, air-conditioning equipment, office devices, vending machines, and other domestic appliances.

Although an embodiment of the present invention has been described in detail above with reference to the drawings, a specific configuration is not limited to this embodiment, and designs and the like are also encompassed in the patent claims, provided such designs and the like do not depart from the spirit of the present invention.

### INDUSTRIAL APPLICABILITY

The present invention is suitably applicable to a base station apparatus, a terminal apparatus, and a communication method.

The present disclosure contains subject matter related to that disclosed in Japanese Priority Patent Application JP 2015-098653 filed in the Japan Patent Office on May 14, 2015, the entire contents of which are hereby incorporated by reference.

### REFERENCE SIGNS LIST

1 Base station apparatus

2 Terminal apparatus

101 Higher layer processing unit

102 Control unit

103 Transmitting unit

104 Receiving unit

105 Transmitting and receiving antenna

1011 Radio resource control unit

1012 Scheduling unit

1031 Coding unit

1032 Modulating unit

1033 Downlink reference signal generating unit

1034 Multiplexing unit

1035 Radio transmitting unit

1041 Radio receiving unit

1042 Demultiplexing unit

1043 Demodulating unit

1044 Decoding unit

201 Higher layer processing unit

202 Control unit

203 Transmitting unit

204 Receiving unit

205 Channel state information generating unit

206 Transmitting and receiving antenna

2011 Radio resource control unit

2012 Scheduling information interpreting unit

2031 Coding unit

2032 Modulating unit

2033 Uplink reference signal generating unit

2034 Multiplexing unit

2035 Radio transmitting unit

2041 Radio receiving unit

2042 Demultiplexing unit

2043 Signal detecting unit

1. A base station apparatus for performing communication with a terminal apparatus under first and second communication schemes differing in allowable delay time from each other,
the base station apparatus notifying the terminal apparatus of pre-scheduling information including information indicating a plurality of resource candidates that are used in the first communication scheme,
the base station apparatus entering a receiving operation of the first communication scheme in a resource indicated by the plurality of resource candidates.

2. The base station apparatus according to claim 1, wherein the base station apparatus incorporates, into the pre-scheduling information, information indicating an order of priority of the plurality of resource candidates.

3. The base station apparatus according to claim 1, wherein the base station apparatus incorporates, into the pre-scheduling information, information associated with a demodulation reference signal that the terminal apparatus transmits.

4. The base station apparatus according to claim 1, wherein in conformity with a request from the terminal apparatus, the base station apparatus notifies the terminal apparatus of information that reconfigures the pre-scheduling information.

5. The base station apparatus according to claim 1, wherein the pre-scheduling information includes information indicating a period of time during which the terminal apparatus is permitted communication based on the first communication scheme, and
the base station apparatus enters the receiving operation of the first communication scheme in the period of time.

6. The base station apparatus according to claim 1, wherein in a case where the base station apparatus performs communication with a plurality of terminal apparatuses including the terminal apparatus under the first communication scheme, the base station apparatus notifies the plurality of terminal apparatuses of the pre-scheduling information in common.

7. A terminal apparatus for performing communication with a base station apparatus under first and second communication schemes differing in allowable delay time from each other,
the terminal apparatus acquiring pre-scheduling information of which the base station notifies the terminal apparatus, the pre-scheduling information including information indicating a plurality of resource candidates that are used in the first communication scheme,
the terminal apparatus sing at least one resource of the plurality of resource candidates in a case of performing communication under the first communication scheme.

8. The terminal apparatus according to claim 7, wherein in a case where the terminal apparatus performs communication under the first communication scheme, the terminal apparatus selects different resources from among the plurality of resource candidates and uses the different resources for a first-transmit signal and a retransmit signal, respectively.

9. A communication method by which a base station apparatus performs communication with a terminal apparatus under first and second communication schemes differing in allowable delay time from each other, comprising the steps of:
notifying the terminal apparatus of pre-scheduling information including information indicating a plurality of resource candidates that are used in the first communication scheme; and
entering a receiving operation of the first communication scheme in a resource indicated by the plurality of resource candidates.

10. (canceled)
